(19) United States
(12) Patent Application Publication
(10) Pub. No.: US 2014/0165364 A1
(43) Pub. Date: Jun. 19, 2014

(54) ASSEMBLY DEVICE FOR THE ASSEMLY OF A HOLDING ELEMENT FOR ATTCHMENT PARTS ON A MOTOR VEHICLE AND METHOD FOR THE ASSEMBLY OF ATTACHMENT PARTS ON A MOTOR VEHICLE

(71) Applicant: GM GLOBAL TECHNOLOGY OPERATIONS LLC, Detroit, MI (US)

(72) Inventors: Klaus LABBE, Udenheim (DE); Frank HOELZER, Weisel (DE)

(73) Assignee: GM GLOBAL TECHNOLOGY OPERATIONS LLC, Detroit, MI (US)

(21) Appl. No.: 14/097,735

(22) Filed: Dec. 5, 2013

(30) Foreign Application Priority Data
Dec. 5, 2012 (DE) 10 2012 023 770.7

(51) Int. Cl. B23P 19/04

(52) U.S. Cl. CPC B23P 19/04
USPC 29/464; 29/281.4

(57) ABSTRACT

An assembly device is provided for the assembly of a holding element for attachment parts on a motor vehicle. The assembly device includes, but is not limited to a linkage with three-dimensional multi-point fixing on the motor vehicle. The linkage includes, but is not limited to a number of reference elements for placing against reference surfaces on the motor vehicle and a mounting for the holding element connected to the linkage.

### CROSS-REFERENCE TO RELATED APPLICATION

This application claims priority to German Patent Application No. 10 2012 023 770.7, filed Dec. 5, 2012, which is incorporated herein by reference in its entirety.

### TECHNICAL FIELD

The technical field relates to an assembly device for the assembly of a holding element for attachment parts on a motor vehicle, for example for headlamps, bumpers or radiator grille. The technical field further relates furthermore to a method for the assembly of such attachment parts.

### BACKGROUND

From DE 10 2009 006 773 A1 it is known to provide a fastening module, by means of which a lamp unit is fastened to a motor vehicle front end support. During the assembly of such attachment parts, the process of the alignment of the individual attachment parts is critical. The vehicle substructure and thus the parts on which the attachment parts are fastened are subject to tolerances. However, very high demands are made on the outer skin of the vehicle, it is to show a uniform joint appearance for an accurately fitting assembly of attachment parts, the vehicle body is therefore often measured and tolerances subsequently offset. However, this procedure is very elaborate.

In view of the foregoing, at least object therefore is to provide an assembly device, with which attachment parts can be mounted on a vehicle economically and at the same time in an accurately fitting manner. Furthermore, a method is also provided for the assembly of attachment parts on a motor vehicle. Furthermore, other objects, desirable features and characteristics will become apparent from the subsequent summary and detailed description, and the appended claims, taken in conjunction with the accompanying drawings and this background.

### SUMMARY

According to an embodiment, an assembly device is provided for the assembly of a holding element for attachment parts on a motor vehicle. The assembly device includes a linkage with three dimensional multi-point fixing on the motor vehicle. The linkage comprises a number of reference elements for placement against reference surfaces on the motor vehicle. Furthermore, the assembly device includes a mounting for the holding element connected to the linkage.

The assembly device is suitable in particular for the assembly of attachment parts in the front region of the vehicle, in particular for the assembly of a headlamp, of a bumper and of a radiator grille. According to an embodiment, these attachment parts are connected to body components of the vehicle, however not directly. A holding element is rather employed, which serves as multi-functional reference plate for the attachment parts and is arranged between the body components and the attachment parts.

The assembly device is used in order to align the holding element in such a manner that following the assembly of the attachment parts on the holding element specifications regarding gap dimension and flushness are maintained. It comprises a number of reference elements, for example four, which can be fixed on predetermined reference points on the motor vehicle, thereby temporarily fixing the assembly device with respect to the vehicle. Thus, the mounting for the holding element and thus the holding element itself is also fixed and aligned with respect to the vehicle. The holding element can then be assembled and because of its correct alignment forms a common, stable reference for the attachment parts.

The reference points on the vehicle are located in particular at or on the engine hood and in the region of the fenders. The attachment parts headlamp, bumper and radiator grille namely have to be aligned relative to the engine hood and to the fenders. The number of the reference elements and reference surfaces is dependent in particular on their type, for example on whether the reference elements are formed for example as clamps. For the type of fixing on the reference points determines in how many and in which directions fixing takes place. In particular, at least three reference elements and reference surfaces each are provided. The assembly device, which is employed together with the holding element for the attachment parts, thus allows the accurately fitting and simultaneously very economical assembly of the attachment parts.

In an embodiment, the reference elements are formed as clamps for engaging about regions of the motor vehicle in the region of the reference surfaces. The reference elements can also be formed as magnetic elements for the magnetic fixing in the region of the reference surfaces. In particular, the assembly device can include both clamps as well as magnetic elements if some reference points on the body are not accessible with clamps while others are. Magnetic elements are suitable for example if a reference element is to be fixed on the engine hood, while clamps are suitable for engaging about edges or flanged edges of the engine hood or the fenders. The reference points on the body are formed as reference surfaces. Because of the condition of its reference elements, the assembly element can be fixed on these reference surfaces. It is consequently not necessary to provide bores on the reference points.

In an embodiment, surfaces of the reference elements, which are placed against the reference surfaces on the motor vehicle, are formed resiliently. In particular, these surfaces can be designed soft, so that they do not leave any damages on the vehicle. This is advantageous if the assembly of the attachment parts is carried out on the already painted vehicle and paint damages can be avoided in this way. For example, the surfaces can comprise soft rubber-elastic or textile linings.

In an embodiment, surfaces of the reference elements, which are placed against the reference surfaces on the motor vehicle, are designed replaceable. For example, these surfaces can comprise resilient, replaceable linings. This has the advantage that the surfaces in the case of wear or dirt accumulation can be replaced. It is thereby ensured that an accurate reference is always available and that damages on the vehicle are avoided.

In an embodiment, the linkage comprises plastic and/or light metal. This has the advantage that the assembly device is designed light. It can thus be easily handled in the assembly process. In addition, the holding forces to be generated on the reference points are not too great. This likewise helps avoiding damages on the vehicle. In particular, the linkage can comprise plastic parts which are reinforced by means of an aluminum or carbon fiber frame structure. It is thus light and also has adequate strength at the same time, so that it is not distorted. Because of this, the accuracy of the assembly is not impaired even after an extended period of use.

In an embodiment, the holding element for fastening a plurality of attachment parts is formed on the motor vehicle. It thus serves as a common reference for a plurality of attachment parts and renders the assembly of the attachment parts particularly economical. In particular, the holding element can be formed for fastening the headlamp as well as the radiator grille and/or the bumper.

In an embodiment, the assembly device is formed for the assembly of at least one holding element for attachment parts both on a right as well as on a left vehicle side, so that for example holding elements for both front headlamps can be jointly assembled. Here, either separate holding elements can be provided on the left and right which can be received on a common assembly device or a common holding element is used, which is formed as a unit from the start or is formed of an assembly of left and right holding element. The assembly device then comprises corresponding reference elements on the left and on the right side which can all be simultaneously fixed on the vehicle. Using such a holding element or such an assembly device has the advantage that the step of positioning and screwing of the holding element only has to be carried out once.

According to an embodiment, a method is provided for the assembly of attachment parts on a motor vehicle. The method includes the releasable fixing of a linkage with three dimensional multi-point fixing on the motor vehicle. The linkage with a number of reference elements is placed against reference surfaces on the motor vehicle. The method furthermore comprises the aligning of a mounting connected to the linkage, the equipping of the mounting with a holding element for the attachment parts, the connecting of the holding element to the motor vehicle and the connecting of attachment parts to the holding element. The releasable fixing of the linkage can be effected in particular with clamps and/or magnetically. In an embodiment, the holding element is screwed to the motor vehicle. Another type of permanently connecting, for example by means of welding or gluing, is also conceivable. In particular, a headlamp, a radiator grille and/or a bumper of the motor vehicle are fastened to the holding element. As reference surfaces, surfaces on an engine bonnet and/or on a fender are used.

With this method, the engine hood, by way of hood buffer and hood lock, can be initially aligned and fixed accurately fittingly with respect to the two fenders. Following this, the holding element is prepositioned on the assembly device serving as assembly jig. The assembly device is attached in the opening region of engine hood and fender and fixed on the reference points. In this position, the holding element can then be screwed accurately fittingly to the body. Conversely, however, prepositioning of the holding element on the assembly device can alternatively be also carried out after the aligning and fixing of the assembly device. Holding elements or a single holding element for the left and right vehicle side can be jointly positioned and assembled in order to save time and thus production costs.

### BRIEF DESCRIPTION OF THE DRAWINGS

The present invention will hereinafter be described in conjunction with the following drawing figures, wherein like numerals denote like elements, and:

FIG. 1 is schematically shows a perspective view of an assembly device for attachment parts of a motor vehicle according to an embodiment from a first angle;

FIG. 2 is schematically shows the assembly device according to FIG. 1 from a second angle;

FIG. 3 is schematically shows a detail from a motor vehicle with a schematic diagram for the arrangement of the assembly device; and

FIG. 4 is schematically shows a detail from a motor vehicle with a further schematic diagram for the arrangement of the assembly device.

### DETAILED DESCRIPTION

The following detailed description is merely exemplary in nature and is not intended to limit application and uses. Furthermore, there is no intention to be bound by any theory presented in the preceding background or summary or the following detailed description.

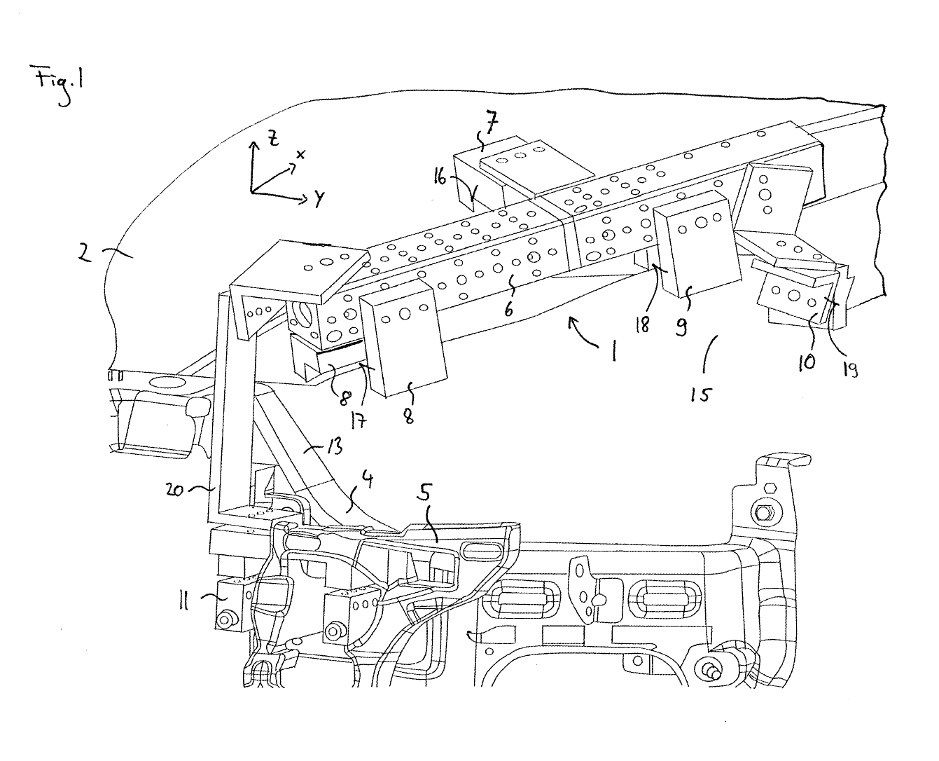

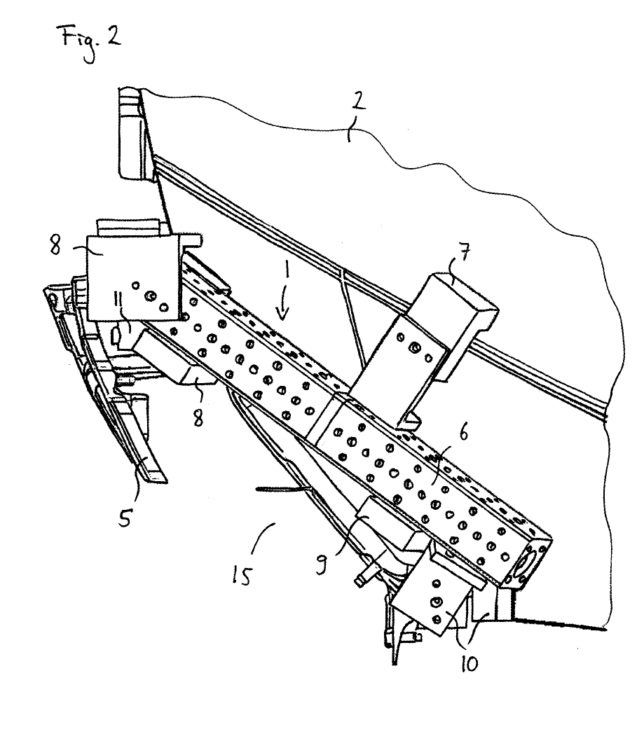

FIG. 1 and FIG. 2 show an assembly device 1 for attachment parts in the front region of a motor vehicle, in particular for the radiator grille, the headlamp and the bumper, according to an embodiment. The assembly device comprises a linkage 6, with which a number of reference elements 7 to 10 is connected.

The first reference element 7 is provided for the magnetic fixing on the linkage 6 on a first reference surface 16 on the engine hood 2. It serves for fixing the linkage in z-direction. The second reference element 8 and the third reference element 9 are formed as clamps. These engage about a second and third reference surface 17 and 18 respectively on the edge of the engine bonnet 2. These serve for fixing the linkage 6 in y and z-direction. The fourth reference element 10 is formed as a placement piece and is placed against a fourth reference surface 19. It serves for fixing in x-direction and thus limits the length of the opening 15 in the body provided for the attachment of the attachment parts, in particular of the headlamp. The fourth reference element 19 is moveably, in particular articulatedly connected to the linkage 6.

The assembly device 1 furthermore comprises an outrigger 20 of the linkage 6, which carries a mounting 11 for a holding element 5. The holding element 5 is fixed on the mounting 11 in z and y-direction and displaceable in x-direction. The holding element 15 comprises fastening regions which are not shown in more detail for fastening, in particular screwing to a cross member 4 of the vehicle substructure 13. In addition to this, it comprises a plurality of likewise not shown fastening regions for fixing, in particular screwing of the attachment parts to the holding element 5.

During the assembly, the linkage 6 equipped with the holding element 5 is initially placed in the opening 15 in such a manner that the reference elements 7 to 10 can be fixed on the reference surfaces 16 to 19. Through movement in the x-direction, the holding element 5 is subsequently brought into the screwing plane, which in FIG. 4 is schematically indicated by the interrupted line 21, where it is screwed to the cross member 4. Following this, the attachment parts can be fixed on the holding element 5.

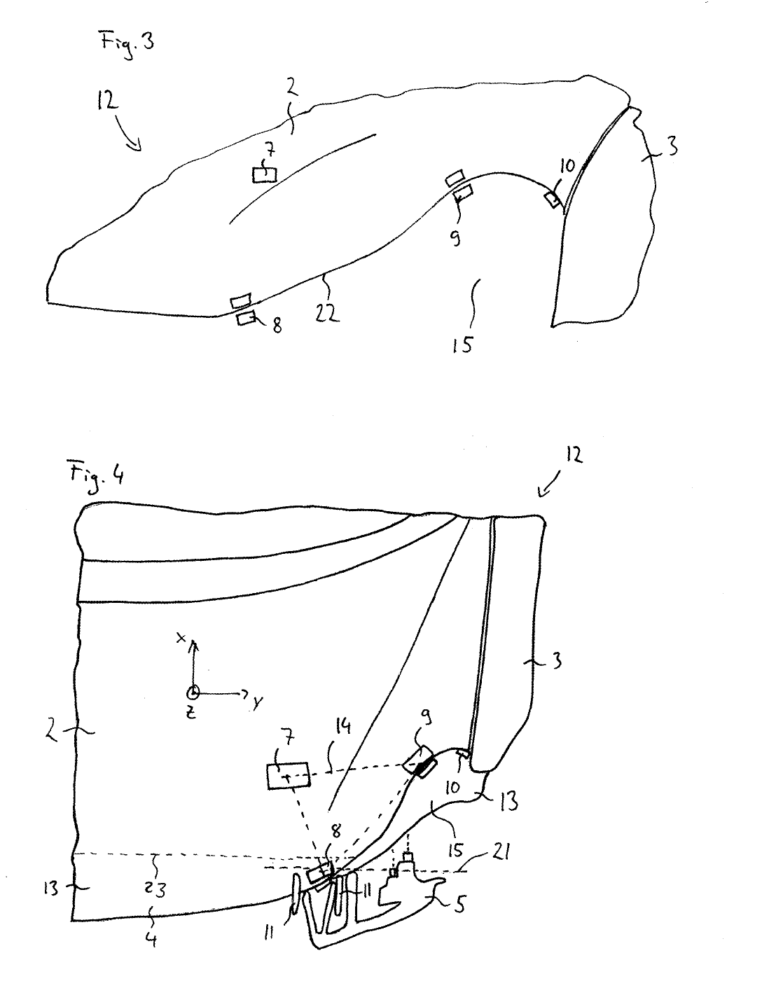

FIG. 3 schematically shows the arrangement and configuration of the reference elements 7 to 10 in the opening 15 of engine bonnet 2 and fender 3. Here it is noticeable that the first reference element 7 is arranged in the middle centrally on the engine hood 2 while the second and third reference element 8 and 9 respectively as clamps engage about the flanged edge 22. The fourth reference element 10 is arranged on the rear edge of the opening 15.

FIG. 4 schematically shows a top view of the engine bonnet 2 from above of a motor vehicle 12 with the reference elements 7 to 9 arranged thereon, which form a triangle, and the reference element 10. The interrupted line 23 marks the position of the cross member 4 of the substructure 13, which in this view is concealed by the engine bonnet 2.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. An assembly device for the assembly of a holding element for attachment parts on a motor vehicle, comprising:
a linkage with three dimensional multi-point fixing on the motor vehicle, wherein the linkage comprises a number of reference elements for placing against reference surfaces on the motor vehicle; and
a mounting for the holding element connected to the linkage.

2. The assembly device according to claim 1,
wherein the reference elements are formed as clamps for engaging about regions of the motor vehicle in the region of the reference surfaces.

3. The assembly device according to claim 1,
wherein the reference elements are formed as magnetic elements for the magnetic fixing in the region of the reference surfaces.

4. The assembly device according to any one of the claim 1,
wherein surfaces of the reference elements, which are placed against the reference surfaces on the vehicle, are formed resiliently.

5. The assembly device according to claim 1,
wherein surfaces of the reference elements, which are placed against the reference surfaces on the motor vehicle, are formed replaceable.

6. The assembly device according to claim 1,
wherein the linkage comprises a plastic.

7. The assembly device according to claim 1,
wherein the linkage comprises plastic parts which are reinforced with an aluminum.

8. The assembly device according to claim 1,
wherein the holding element is formed for fastening a plurality of attachment parts on the motor vehicle.

9. The assembly device according to claim 1,
wherein the holding element is formed for fastening the headlamp as well as the radiator grille.

10. The assembly device according to claim 1,
wherein the assembly device is formed for the assembly of a holding element for attachment parts both on a left side as well as on a right vehicle side.

11. A method for the assembly of attachment parts on a motor vehicle, comprising:
releasable fixing of a linkage with three dimensional multi-point fixing on the motor vehicle, wherein the linkage with a number of reference elements is placed against reference surfaces on the motor vehicle;
aligning a mounting connected to the linkage;
equipping the mounting with a holding element for the attachment parts;
connecting the holding element to the motor vehicle; and
connecting attachment parts to the holding element.

12. The method according to claim 11,
wherein the releasable fixing on the linkage comprises clamping.

13. The method according to claim 11,
wherein the releasable fixing on the linkage comprises magnetically fixing.

14. The method according to claim 11,
further comprising fastening a headlamp on the holding element.

15. The method according to any one of the claim 11,
further comprising using surfaces on an engine bonnet as reference surfaces.

16. The assembly device according to claim 1, wherein the linkage comprises a light metal.

17. The assembly device according to claim 1, wherein the linkage comprises plastic parts which are reinforced with a carbon fiber frame structure.

18. The assembly device according to claim 1, wherein the holding element is formed for fastening the headlamp as well as the bumper.

19. The method according to claim 11, further comprising fastening a radiator grille on the holding element.

20. The method according to claim 11, further comprising using a fender as reference surfaces.
